(19) United States
(12) Patent Application Publication
(10) Pub. No.: US 2008/0201229 A1
(43) Pub. Date: Aug. 21, 2008

(54) System and Method for Providing a Representation

(76) Inventor: Steven Daniel Metzman, Wynnewood, PA (US)

Correspondence Address: BUCHANAN INGERSOLL & ROONEY PC, P.O. BOX 1404, ALEXANDRIA, VA, 22313-1404, US

(21) Appl. No.: 12/032,147

(22) Filed: Feb. 15, 2008

Related U.S. Application Data
(60) Provisional application No. 60/902,014, filed on Feb. 16, 2007.

(51) Int. Cl. G06Q 99/00

(52) U.S. Cl. 705/14; 705/1

(57) ABSTRACT

A system and web-based representation is provided. The representation may be used to supplement an application to an institution, be used as an application to an institution or be a portion of such an application. The representation features multimedia, including, for example, but not limited to video, audio, or textual representations of an applicant. Applicants may be applying, for example, to college, private school, graduate school, vocational/technical school, or schools for specialized studies including but not limited to performing or fine arts. Profit models based on this representation are also described. The information or computer instructions (for example, embedded code) uploaded by an applicant is stored in at least one database that is incorporated in a system used to populate one or multiple web pages for the applicant. For example, the one or more databases may be stored in memory operatively connected to a server. This content may be viewed by admissions professionals.

### CROSS REFERENCE TO RELATED APPLICATIONS

The present application claims the benefit under 35 U.S.C. § 119(e) of pending U.S. Provisional Patent Application Ser. No. 60/902,014 that was filed on Feb. 16, 2007. The entirety of U.S. Provisional Application Ser. No. 60/902,014 is incorporated herein by reference.

### FIELD OF THE INVENTION

Embodiments of the invention are directed to the fields of applications, particularly college applications, graduate school applications, private school applications, vocational/technical school applications, and other specialized school applications.

### BACKGROUND OF THE INVENTION

School admissions processes have grown increasingly competitive. Traditionally, one applies for college, graduate school, private school, vocational/technical school, and schools of specialized focus by first providing a text application. Such a text application may take the traditional print form, may be submitted electronically, or may be an entirely online application including answers to personal questions, test scores, essays, and the like. Such applications may include the so-called “Common Application” and the “Universal College Application.” In conjunction with such applications, supplemental information such as institution-specific questions, personal interviews and the like may also be provided by an applicant. Such supplemental information is often needed for admissions personnel to develop a deeper understanding of the applicant adequate enough to render a proper admissions decision.

Although the traditional application method may be effective in certain circumstances, it has a number of drawbacks. For example, the steadily increasing number of applications received by schools can make interviewing or auditioning apparently marginal candidates both time- and cost-prohibitive. Furthermore, the written application alone may not be sufficient to convey the extent and nature of an applicant's personal qualities considered during admissions decisions or other attributes considered relevant in the admissions process. Furthermore the applicant's geographical location, financial circumstances, physical impairment, or other limitations may prohibit a personal interview. Moreover, financially or otherwise disadvantaged students may not receive equal opportunity to personally present themselves to admissions personnel by the fact that they cannot travel to prospective campuses as is done by their counterparts. No written application can be a substitute for visual presentation and for seeing a student in action. Furthermore, where an applicant is successful in proceeding past the initial screening in a school of specialized focus or partially in consideration on the basis of specialized ability, athletic performing or otherwise, submission of multiple performance or audition tapes, disks or other media becomes an inconvenient, inefficient exercise and may be avoided by decision-makers for fear of computer virus, software conflicts or other technological considerations.

It would be desirable to provide an application or an application supplement that overcomes one or more of the above-mentioned disadvantages.

### SUMMARY OF THE INVENTION

Embodiments of the invention provide a website or other system that allows applicants to present themselves to admissions professionals in a multimedia format. Useful multimedia includes, for example, but is not limited to, audio media, video media, visual media or a combination thereof. Applicants who take advantage of a website or other system as described herein are given an advantage over those applicants who limit themselves to more traditional application methods. In one embodiment of the invention, an applicant uses a computer to access a website where relevant information of all types, and multimedia files (including, for example, video or audio clips) can be stored in a database on the server for use as incorporating into a supplement or representation for use as an application or a supplement to an application.

Admissions personnel are given an advantage by receiving additional, quickly evaluated relevant applicant information on which to base their admissions decision. In one embodiment, an admissions professional is able to use a computer or other internet browsing apparatus to connect to the website, where the professional is able to view the personal information and multimedia. A professional can control certain aspects of the multimedia delivery to suit their needs and preferences. A professional is also able to search the existing database by any desired criteria to find applicants who would be suitable for admission at the professional's school or to search to find applicants that have a significant interest in attending their school. The professional can use the information on the website to contact the applicant, either directly or through the website, or may simply use the information obtained from the search to help make an admissions determination related to a particular applicant.

In some embodiments, a system may be configured to permit a user to search for different institutions based on one or more attributes an institution may have. Such a search may include a search of one or more databases that include attributes for numerous institutions, such as colleges and universities. A prospective student may conduct such a search to identify various colleges that have attributes the student is looking for. In one embodiment, the institutions identified from such a search may be sent a communication indicating the searcher's potential interest in the institution. Such a communication may help the institution identify potential new students to recruit or send marketing materials to.

In some embodiments of the invention, any applicant is able to upload or embed links to the server or one or more other open servers for lower resolution or shorter length multimedia for no cost to the applicant, but an applicant may enable delivery of higher resolution or otherwise preferable multimedia converted to a unified delivery format for a fee. Admissions professionals may pay a registration fee for access to such information. Access may also be provided for free, or based on the number of applicants viewed. Professionals may also be charged a fee to obtain search functionality or increased search functionality.

### DESCRIPTION OF THE FIGURES

FIG. 1 provides one embodiment of the present invention that includes an applicant's individualized web page of an applicant displaying access options to underlying elements as might be viewed by an admissions professional.

FIG. 2 provides a flow chart of operation of a website embodiment of the invention, as viewed from the perspective of an applicant and admissions professional. Not all of the options shown on the flowchart are required.

FIG. 3 provides a separate website outline of embodiments of the invention.

FIG. 4 provides another embodiment of the present invention that includes an applicant's individualized web page with access to underlying elements as might be viewed by an admissions professional.

FIG. 5 illustrates an embodiment of the present invention that includes a system that has a server and one or more computers configured to interact with the server. The server has memory and at least one processor configured to provide website services to one or more users that access a website to view, upload or download certain content offered on the website.

### DESCRIPTION OF PRESENT PREFERRED EMBODIMENTS OF THE INVENTION

Embodiments of the invention provide a website or other system that allows applicants, for example, applicants to college, graduate school, private school, vocational/technical school, and schools for specialized studies, to prepare a representation that permits them to present themselves in a multimedia format. Schools for specialized studies include, for example, but are not limited to, schools for the visual, musical, theater, and dancing arts. This is useful for all applicants, and particularly those who wish to emphasize their speaking skills, presentation skills, athletic prowess, artistic or otherwise unique abilities or use the invention to convey qualities or personal considerations not otherwise as effectively communicated. This allows admissions professionals to view and critique applicants without either party having to expend the time and money to meet face-to-face. Additionally, certain limitations such as, but not limited to, financial, physical, or temporal limitations that can prevent applicants from personally meeting with on-campus admissions officers are also mitigated, if not eliminated, with such representations.

An applicant may provide or upload information to a server that is compiled in a database for use in a website. It should be appreciated that data that may be input or uploaded by the user and arranged in a database includes, but is not limited to, name, address, email address, gender, academic and non-academic attributes, other attributes or descriptions of the applicant that the applicant or representative feel are most compelling, grade point average, class rank, planned career, intended major, languages spoken by the applicant, computer ownership, languages spoken in household, household income, telephone number, URL for personal website, hobbies, sports participation, extracurricular activities, academic and other awards, prizes, clubs, community service, desired type of college (i.e. selectivity level or other criteria) or work experience. The user may also upload original essays, copies of prior essays, newspaper articles, letters of reference and other materials of varying form.

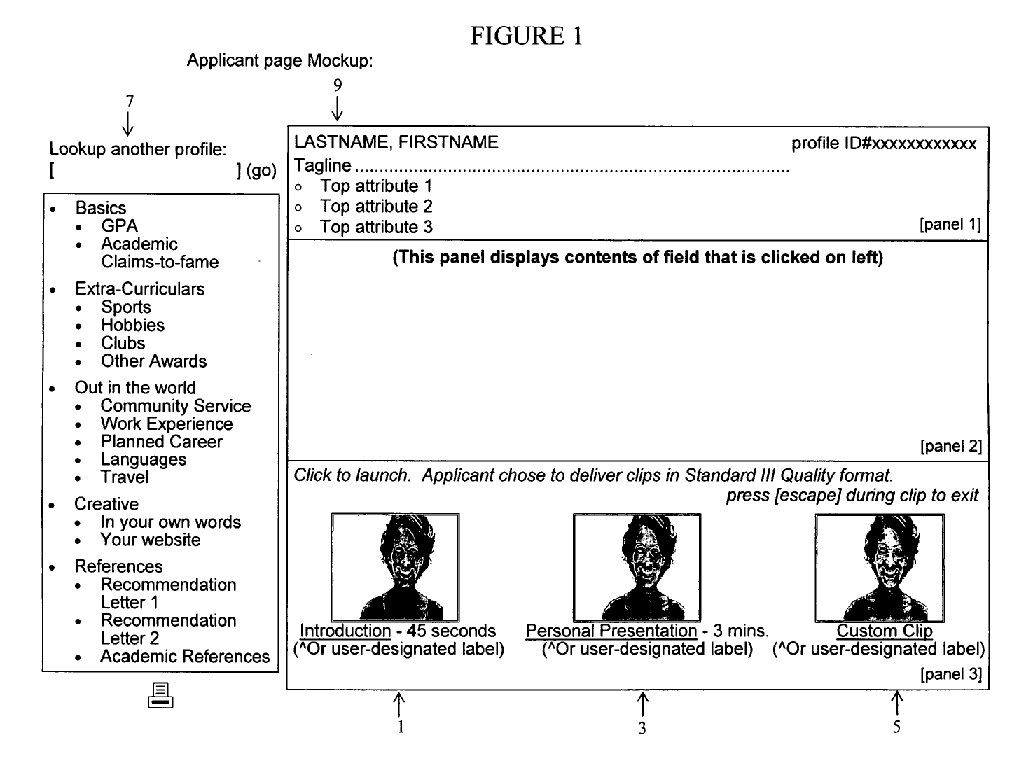

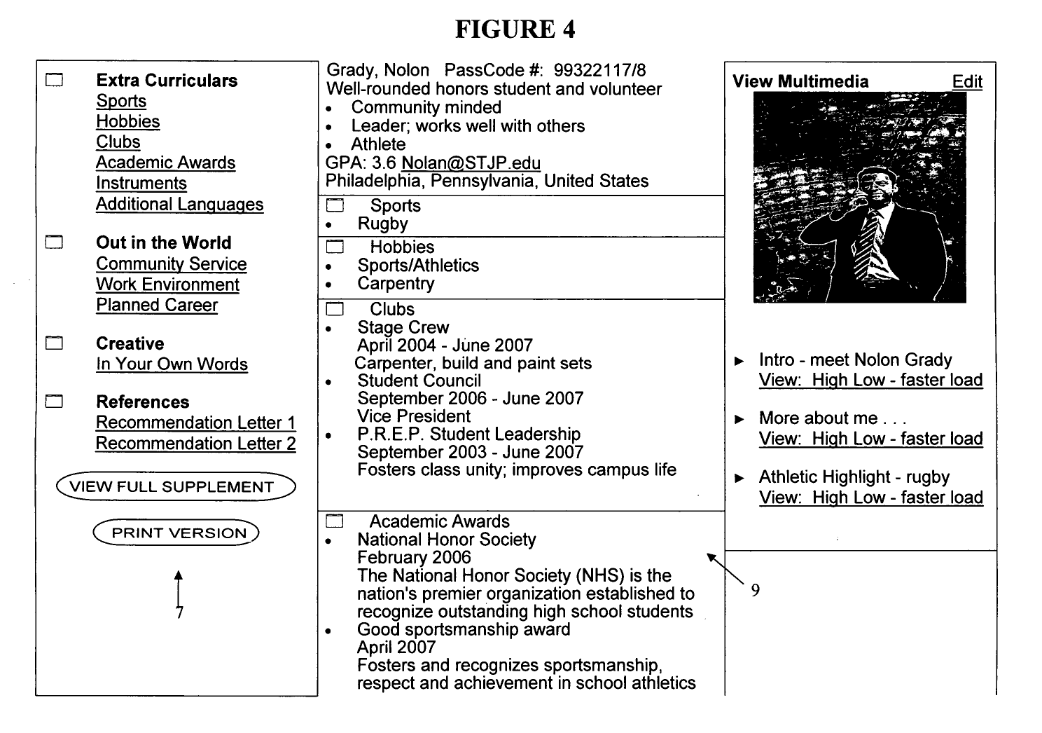

The website may generate one or more web pages devoted to the applicant. As shown in FIG. 1, features provided by the website may include, for example, displaying video clips 1, 3, and 5, as well as an information display panel 7 and featured attributes 9. The featured attributes 9 may include, but are not limited to, extracurricular activities of significance, noteworthy academic or athletic achievements, work experience, community service, or various other distinguishing skills an applicant may have. The information display panel 7 may include a brief breakdown of various background related facts such as an applicants' age, sex, athletic and academic achievements, artistic endeavors, reference letters, career goals, work or volunteer experience and other noteworthy information that may be relevant to an admissions process. Such information may also include website links to various articles written by or about an applicant or websites or web pages developed or otherwise created by the applicant. As shown in FIG. 4, the display panel 7 may also include links to different attributes that may be selected to have the selected attributes prominently displayed in the featured attribute 9 portion of the web page or in a separate web page that opens upon the selection of a link in the display panel 7.

The display panel 7 may also be configured to provide display a certain set of links that identify attributes an applicant has as being operative and other links related to attributes an applicant may not have as not being operative. By only having links that are related to the particular attributes of an applicant shown as operative, an admissions office reviewing the display panel 7 may immediately appreciate the breadth of the attributes or experience an applicant may have.

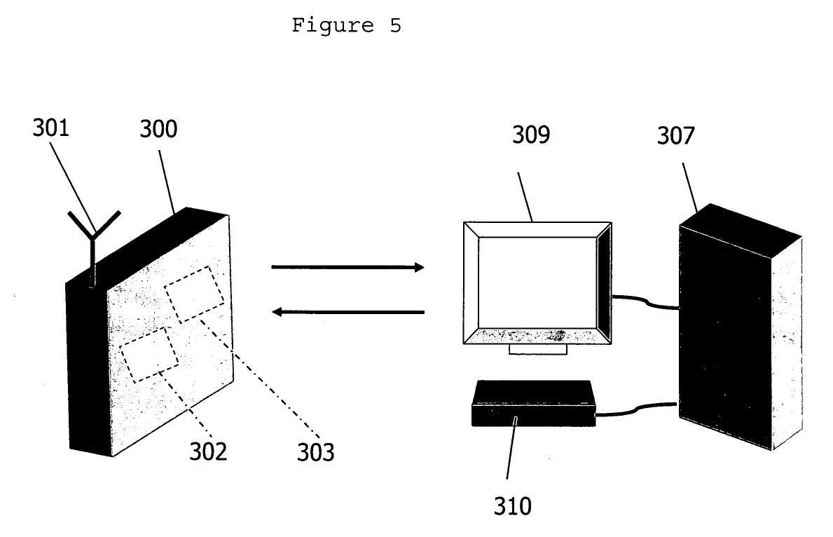

As shown in FIG. 5, an embodiment of the invention may include a system that includes data stored in memory 303 in at least one server 300. One or more processors 302 can be operatively connected to the memory 303. A transceiver 301 may also be operatively connected to the one or more processors 302. It should be understood that the transceiver may include one or more receivers and one or more transmitters. The one or more processors 302 may access the data stored in the memory 303 and transmit the data or at least one output created based on at least a portion of the data to various devices that may connect to the server 300 such as internet browsing apparatuses or other networking devices.

For example, computers 307 or other devices may be configured to be operatively connected to the one or more servers 300 to access or interact with the website or receive website services. Web pages of the website may be displayed on display devices, such as a monitor 309 operatively connected to a computer 307. Of course, other user devices can be configured to access the server including but not limited to a cellular phone or personal digital assistant. Such other user devices may also be used to interact with the server to access the website. A user may use a keyboard 310, a key pad, a mouse, a stylus or other component operatively connected to the computer 307 to transmit data to the server to access the website or certain web pages of the website. One or more programs stored in the memory 303 or one or more programs operatively connected to the memory 303 or the processor 302 may be configured to perform searches of the data within the memory 303.

In other embodiments, the data stored in the memory 303 may include databases or programs configured to access databases to populate, display, offer or create one or more web pages of a website or a program that may be operatively connected to a computer 307 or other device that permits a user to interact with or use the one or more programs or search the one or more databases. In one example, the memory 303 may include only databases and a user may have one or more programs installed on a computer 307 or other device configured to operatively connect to the server 300 to search or otherwise access the databases stored in the memory 303 or otherwise perform functionality. The data in the memory 303 may be updated periodically so the program on the computer 307 or other device may search or otherwise access the updated information or provide desired functionality. The program may be sold to a user or offered to the user at no cost. Similarly, access to the data stored in the memory 303 may be sold to the user or provided at no cost. In some embodiments, the program may be provided at one price and the access to the data stored in the memory may be provided at a second, separately charged cost. Of course, the cost for access to the data stored in the memory 303 may be billed differently to a user than use of the program.

It should be appreciated that the term “operatively connect,” as used herein, refers to a connection that permits one apparatus to interact with another apparatus. For example, a processor may be operatively connected to a server by a wireless connection, a wired connection, or by being an integral part of the server. As another example, a server may be operatively connected to a user device when the user device is able to communicate with the server or download or upload information to the server or a component of the server. As yet another example, a program may operatively connect memory to a processor if the processor is configured to run the program and access the memory for certain data or desired functionality as a result of running the program.

In some embodiments of the invention, one or more web pages for each applicant may be populated from a database that contains information uploaded by the applicant or the applicant's representative. Fields that contains no information would not be displayed. Alternatively, various fields could be left blank unless the applicant or an interested admissions person paid a fee to permit the display of such content. The applicant could also select which information is selected for users with a pass code (described below) and for those without a pass code.

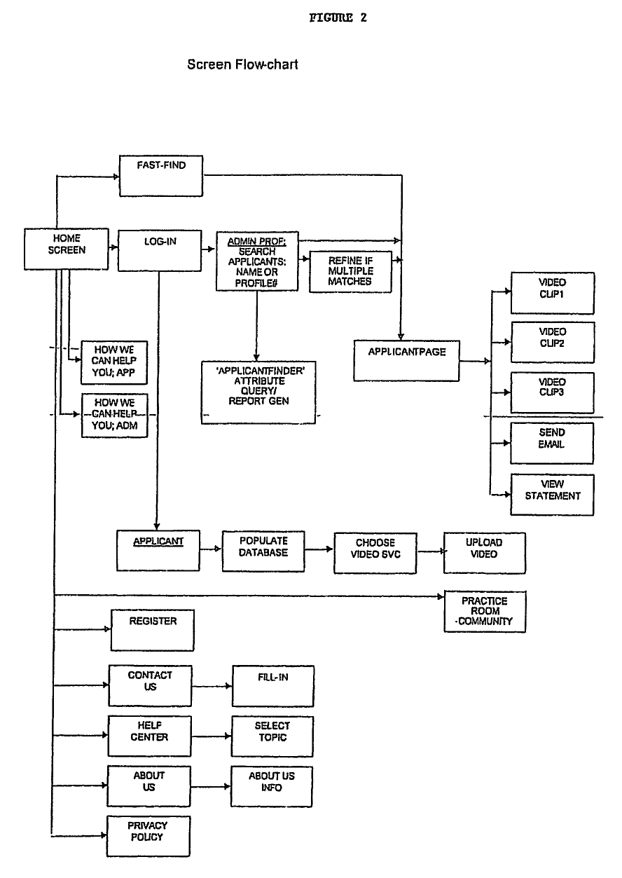

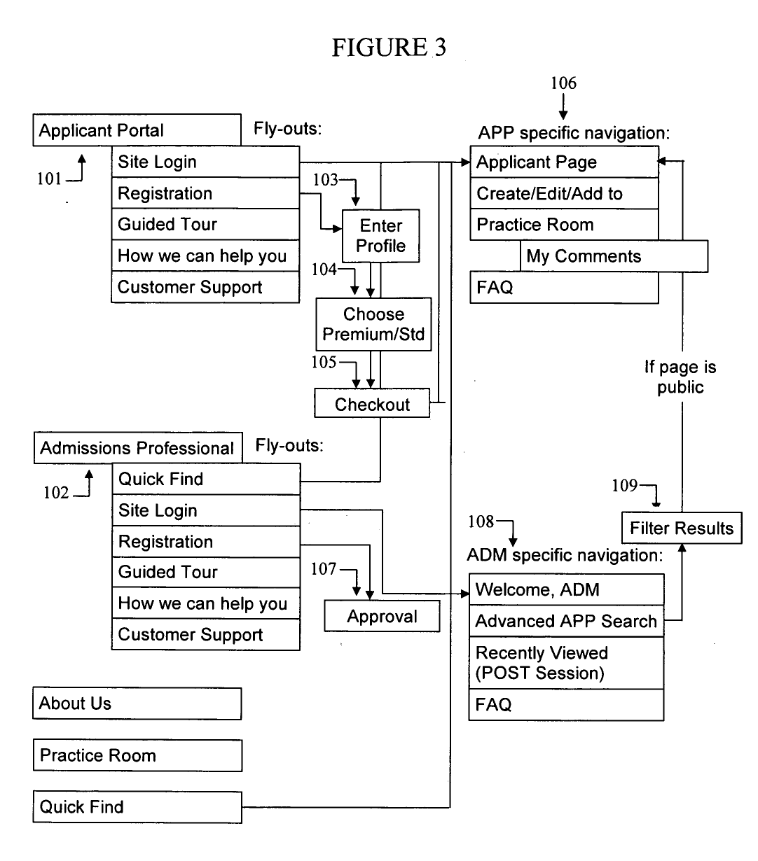

As shown in FIGS. 2 and 3, an applicant or admissions professional may access embodiments of the invention in various different ways. Applicants may access a website embodiment of the invention through a designated applicant portal 101. Once the applicant registers or logs on, the applicant may enter his or her profile 103, identify whether he or she would like to pay for certain premium features or choose a less costly standard or free of charge set of features 104 and then checkout 105 so the user may navigate 106 his or her web pages and other locations on the website the applicant has obtained access to. In navigating his or her web pages, the applicant may edit or revise one or more web pages generated for the applicant based on the profile and associated elements the applicant entered.

An admissions professional may also access a website embodiment of the invention by a portal 102. Certain features of the website may be available without logging in at the portal 102. Access to other features may require a user or admissions professional to log in or register at a certain web page or portal 102. The admissions professional may then view certain applicant web pages or additional applicant web pages based on obtaining approval to view such web pages. Obtaining approval 107 may include entering pass codes or other entry authorization codes. It should be appreciated that an applicant may determine the level of access that can be provided to an admissions professional prior to requiring entry of a pass code or other means of approval.

If the Admissions professional is a registered user, the admissions professional may navigate certain portions of the website 108 to perform searches of applicant data or view certain applicant web pages or multimedia content available to the admissions professional based on either applicant authorization or an applicant's choice to have certain data uploaded or embedded in web pages that may be viewed by the admissions professional. In the event the admissions professional performs any search operations, data being searched will be filtered 109 to identify data or applicants that fall within the search query entered by the admissions professional.

Embodiments of the present invention provide a variety of advantages to both applicants and admissions professionals. By effectively conveying or providing more information relevant to an admissions decision in a user-friendly format, applicants are able to eliminate disadvantages created by socio-economic limitations or physical impairments or gain an advantage over others who do not present such information. Admissions professionals are able to effectively get a more personal sense of the applicants through the multimedia uploaded by the applicants. They are also able to query and solicit potential applicants who might be a desirable “fit” for their school, where those applicants might otherwise not know about the school. Guidance counselors and other secondary school representatives may expand their role in admissions by providing assistance to applicants with the development of the website's components and optimize placement for their students.

Embodiments of the invention may include a system that has a collection of a wide assortment of data from applicants. This allows the applicant to present a complete picture to an admissions officer, it allows an admissions officer to effectively search for qualified candidates, and it allows appropriate marketing efforts to be targeted to site users if desired. Information that is collected may be displayed on an applicant's personal page, it may be undisplayed yet retained for marketing or sales purposes, or it may be undisplayed yet sent to the admissions officer when authorized by the applicant.

Embodiments of the invention may also include websites that may have a variety of search, reporting or printing functionalities for admissions professionals. For example, admissions professionals may search by applicant name, desired applicant attributes, keyword, location (i.e., city or zip code) or any combination thereof. Applicants will also be provided with a unique identity number and in some cases a pass code. This may be provided by the applicant directly to those admissions professionals that the applicant wishes to be able to access the applicant's information. In some embodiments of the invention, a unique pass code is the only way that an applicant's data may be accessed by an admissions professional. In other embodiments, both a unique identity number and a pass code are required. Of course, the system may be configured so that an applicant can generate a new pass code at any time to restrict access to their profile and other information.

In some embodiments, a system, such as a website, can be configured to permit admissions personnel to have access to the applicant's information without providing a unique identifier. For example, the system can be configured to permit an applicant to determine the access admissions personnel may have to the applicant's information prior to having to enter a unique identifier. In another alternative embodiment, the system may be configured so that admissions personnel cannot obtain access to certain applicant information without providing a pass code generated for or by an applicant.

Embodiments of the invention can include a system configured to permit potential applicants to search for colleges or other institutions that have certain qualities or attributes. In one embodiment, a system includes one or more databases of information relating to institutions that identifies various attributes for each institution within the one or more databases. Such attributes may include, but are not limited to, institution size, institution specialties, academic ratings, admissions criteria, athletic program ratings or specialties, and financial costs associated with attending the institution. When a user, such as a potential applicant, conducts a search of the database for institutions meeting certain attributes the applicant has searched for, output would be provided to the user that identifies institutions that have the searched attributes or that provide attributes similar to those searched by the potential applicant. The output may include a web page configured to identify the results of the search, an email or other communication providing the search results, or other output that may identify the search results to the potential applicant.

In some embodiments, the institution identified as being relevant to the search conducting by an applicant will also be sent a communication identifying the potential applicant as someone that may be interested in attending the institution. This may be performed automatically or with selective input provided by a user.

A further embodiment of the invention may provide a “practice room” function. This function will include multimedia uploads from many applicants, each of whom may provide more than one uploaded multimedia element. Users are able to access this content, review the multimedia and provide feedback to the applicant who uploaded the multimedia element. Practice room uploads may be made without providing any personally identifying information aside from appearance and any information in the multimedia itself. In this way the applicants are able to refine their uploaded multimedia based on feedback collected from others and prior to formal presentation on their individual page.

Embodiments of the invention may also include a website that provides various other functionalities to a user, subscriber, applicant, or admissions professional. For example, one embodiment may include a website that permits a user to identify various institutions the user is interested in applying to or rating one or more schools as being the user's favorite institution. Based on such input, the website may be configured to provide one or more communications to the identified institutions to identify the user as an interested applicant or potential applicant. The one or more communications may be an email, a letter, a fax, any combination thereof, or other communication. Such a communication may be sent automatically or with selective input provided by a user. For example, the provided input can include text or audio to include within a communication.

The one or more communications may provide information about the user, a pass code or link to the user's web pages that were developed and are maintained by the website or other information that permits the admissions staff of the identified institutions to contact the user or learn more about the user. The website may also provide one or more web pages that permits an admissions professional to communicate with a user or applicant. Communication may be facilitated in numerous ways. For example, communications may be effectuated through interfacing with existing email systems, or through a communication platform specific to and located within a web page or other portion of a website. For instance, in one embodiment, a communication platform may include a two-way video conferencing platform or other platforms.

Embodiments of the invention may also include a website that permits a user to search information collected from potential applicants to permit admissions professionals to identify prospective students and contact those students. For example, a user may search a database of potential applicants to identify applicants that have indicated a special interest in applying to or rating one or more schools as being the potential applicant's favorite institution. The user may also search the one or more databases of potential applicants for potential applicants that have qualifications that are consistent with a certain user specified or system default profile. For instance, a user may search one or more databases to identify potential applicants that have a certain range of a standardized test score, a certain sex, a certain race, and certain other attributes deemed desirable by a user. The website may be configured to provide one or more communications to potential applicants that have submitted or uploaded information contained within the searched databases. Such communications may be configured to identify the one or more interested parties or schools that conducted a search that identified the potential applicant. The communication may also be configured to identify a user that has conducted a search that indicates the user is interested in the potential applicant. The one or more communications may be an email, a letter, a fax, any combination thereof, or other communication. The website can also be configured to permit the user searching the database or databases to send such a communication automatically or with selective input. For example, the provided input can include text or comments in another format to include within the communication.

One or more communication mechanisms such as, for example, a bulletin board, web page or communication platform located within a website may also he included in a website embodiment of the invention. A communication platform may include, for example, a two-way video conferencing platform or other platforms. The one or more communication mechanisms are configured so that one or more applicants can permit an admissions professional or other user to communicate with the applicants. In one embodiment, an applicant may permit access to a certain portion of his or her information by providing information a user may use to access at least a portion of the applicant's information. The information may be content personally typed, written, or otherwise uploaded by the professional to the website. The communication mechanism may also be configured to permit other users or applicants to view other communications provided to an applicant or just certain portions of those other communications. Such materials may have access protected from view by only those with authorization by use of pass codes or other privacy measures.

An embodiment of the invention may include a website that includes information related to various scholarships, athletic programs, art programs, performances or other programs offered by institutions or other entities to which a user may apply. The website may also be configured to generate a communication to a user that identifies various scholarships or other programs that the user is or may be qualified for based on the information uploaded to the website server or databases accessed by the website. Preferably, the website is configured to permit a user to automatically apply for certain scholarships or other programs the user may be qualified for by sending certain uploaded information to one or more scholarship providers or other program providers. For instance, the website may be configured to send uploaded information in an electronic format based on information uploaded by a user. In another embodiment, the uploaded information may be recorded in a hard copy and physically mailed to the selected scholarship provider. Such services may be provided at no cost to the scholarship or program provider, at some cost to the scholarship or program provider, at some cost to the user or at no cost to the user. In embodiments that do not provide the service at a cost to the user or the scholarship or program provider, profits may be obtained by advertising that may be generated from use of such services or by being captured in a cost charged for various other services rendered by the website or website provider.

Embodiments of the invention may also be configured to create databases that compile information about different high schools or other academic institutions users attend or have graduated from. Such information may be compiled to identify high schools that offer certain academic, athletic or ethnic profiles. For example, a database may be generated that identifies the academic performance of students for a particular high school, the athletic accomplishments of the high school, academic performance of the high school as compared to national averages or other comparison sources, and identify the ethnic composition of the school. Such information may be generated based on user input obtained by the website or be generated from a database compiled from published reports for certain institutions.

Embodiments of the invention may also provide search capabilities to users such as applicants or admissions personnel that permit the users to better identify schools or applicants that merit consideration for application or admission. The search capabilities may include searching databases compiled of user data uploaded to the website. The search capabilities may also include searching databases compiled of college data uploaded to the website. The database or databases may include all the uploaded information or certain selected portions of the database or databases.

Embodiments of the invention offer multiple profit models. In one embodiment, an applicant may pay a fee to increase the quality or quantity of multimedia content that is provided to admissions professionals. Applicants may also be able to increase their available feature set by paying a fee. Information provided by the users may be sold or otherwise distributed to the extent permitted by law. For instance, information provided by an applicant may be distributed to various colleges of the applicant's choosing at a cost to the college or may be provided to different colleges seeking to fill its incoming class with students of a certain background, educational achievement, athletic prowess, experience or other attributes at a cost to the college. Websites of the invention may also include advertising directed to the user's demographic.

Embodiments of the invention may also include providing video recording and other services related to preparing one or more videos. An applicant may obtain such video recording services for a fee and may then have videos created with the aid of such services uploaded or embedded to one or more websites containing additional application related information provided by the applicant. Such services can include providing equipment and manpower necessary to record one or more videos or may include merely providing advice as to how a video should be created, writing a compelling presentation or providing advice related to what multimedia content would be ideal for a particular applicant goal. The video services that are provided may be advertised directly to applicants or be advertised to guidance counselors or other counseling agencies that may serve as a reference to the applicants. The video recording services may be offered at a fixed office, at various locations of the applicant's choosing, in a website or at various other physical or virtual locations.

Yet another embodiment includes cooperating with one or more guidance, counseling or athletics related persons or entities to provide application guidance related services that include such video recording services or other services related to uploading or embedding multimedia to one or more servers to be accessed by other applicants, admissions personnel, counselors or representatives hired by an applicant or others. Preferably, the access to the uploaded or embedded materials is limited to only admissions personnel of the applicant's choosing and others that have obtained the applicant's permission to view the uploaded or embedded multimedia.

In one embodiment, a pass code is provided to an applicant or others the applicant approves of that permits those people to access, view, or copy the uploaded or embedded multimedia. Preferably, the pass codes may be changed as needed by an applicant or may be time-sensitive such that the pass-codes only provide limited access. Such limited access may include a time limit that limits the duration that the pass code allows access. In other embodiments the pass code may be configured to only work a certain number of times to limit the number of times the pass code may be entered to access a particular portion of a website or a articular uploaded or embedded multimedia document. In some embodiments, the video recording services may be bundled with other college admissions, testing, or counseling related services or provided separately from such other services.

While I have shown and described certain present preferred embodiments of the invention and have described certain present preferred methods of practicing the same, it is to be distinctly understood that the invention is not limited thereto but may be otherwise variously embodied and practiced within the scope of the following claims.

I claim:

1. A system configured to provide a representation for use in applying for admittance to at least one institution comprising:
at least one server having at least one database comprised of applicant data and applicant multimedia data, at least one receiver and at least one transmitter, the at least one server configured to provide data for at least one first website, the applicant multimedia data comprised of data uploaded to the at least one database by a user;
at least one processor operatively connected to the at least one server, the at least one processor configured to access the at least one database and cause the applicant data and the applicant multimedia data to be displayed on at least one display device that operatively connects to the at least one server, the at least one processor operatively connected to the at least one transmitter and configured to cause the at least one transmitter to provide a first output that can be received by the at least one display device having at least one screen and formatted into a display design that is displayed on the at least one screen; the at least one processor also operatively connected to the at least one receiver and configured to receive input from the at least one receiver such that the processor can cause at least a portion of the applicant data and applicant multimedia data to be sent as a portion of the first output;
the applicant data comprised of applicant information that is comprised of at least one of attributes, background information, academic performance, work experience, volunteer experience, ethnicity and sex for at least one applicant;
the applicant multimedia data comprised of at least one video recording of at least one applicant, the video recording having audio content and video content; and
wherein the at least one processor is configured to also cause the at least one transmitter to send a second output such that the at least one video recording is at least one of uploaded to and embedded in a website that is accessible by at least one of a computer, cellular phone, display device, personal digital assistant, internet browser and internet search engine; and
wherein the at least one institution is comprised of institutions selected from the group consisting of colleges, universities, private schools, graduate schools, vocational schools, technical schools, schools for specialized studies, public schools, performing schools and fine art schools.

2. The system of claim 1 wherein the second output is sent to a website that is not the first website.

3. The system of claim 1 wherein the first website is comprised of multiple web pages.

4. The system of claim 1 wherein the first website is configured to provide only authorized access to a portion of the application data and multimedia data.

5. The system of claim 1 wherein the authorization is verified by a pass code that is generated by a program operatively connected to the at least one processor.

6. The system of claim 1 wherein the applicant multimedia data is uploaded to the at least one database by at least one user that operatively connects to the at least one server with a computer connected to an interconnected system of networks that connects multiple computers and uploads at least one video recording to the at least one server.

7. A system configured to provide a representation for use in applying for admittance to at least one institution comprising:
at least one server having at least one database comprised of applicant multimedia data, at least one receiver and at least one transmitter, the at least one server configured to provide at least a portion of the applicant multimedia data to at least one user device configured to operatively connect to the at least one server, the at least one user device having at least one display device; the at least one receiver configured to receive input from the at least one user device; and
at least one processor operatively connected to the at least one server, the at least one processor configured to access the at least one database, the at least one processor operatively connected to the at least one receiver and configured to receive at least a portion of the input from the at least one receiver after the at least one receiver receives the input from the at least one user device, the at least one processor operatively connected to the at least one transmitter and configured to cause the at least one transmitter to provide a first output that can be received by the at least one user device such that the processor can cause at least a portion of the applicant multimedia data to be sent as at least a portion of the first output after the at least one user device is operatively connected to the at least one server such that the at least a portion of the applicant multimedia data contained in the first output is used by the at least one user device to display the at least a portion of the applicant multimedia data after the at least one user device is operatively connected to the at least one server.

8. The system of claim 7 wherein the applicant data is comprised of at least one of attributes, background information, academic performance, work experience, volunteer experience, ethnicity and sex for at least one applicant.

9. The system of claim 7 wherein the multimedia content is comprised of at least one video recording of at least one applicant, the at least one video recording having audio content and video content.

10. The system of claim 7 wherein the at least one institution is comprised of institutions selected from the group consisting of colleges, universities, private schools, graduate schools, vocational schools, technical schools, schools for specialized studies, public schools, performing schools and fine art schools.

11. A method of offering application related services to submit a representation for use in applying for admittance to at least one institution comprising:
offering a system configured to provide a representation for use in applying for admittance to at least one institution that personalizes an application by permitting a display of video of an applicant;
marketing the system to at least one of guidance counselors, education consultants, students, prospective students and admissions personnel;
providing a website that is configured to have at least one user upload applicant multimedia data to the website, the applicant multimedia data comprising at least one video;
wherein the website is configured to permit at least one authorized person to view the at least one video.

12. The method of claim 11 wherein the website permits at least one authorized person to view the at least one video on a website that is accessible by an interconnected system of networks that connects multiple computers, the website that displays the at least one video being different than the website to which the at least one user uploaded the multimedia data.

13. The method of claim 11 wherein the website is comprised of at least one server operatively connected to at least one database, the at least one database having a compilation of applicant data comprised of applicant information that is comprised of at least one of attributes, background information, academic performance, work experience, volunteer experience, ethnicity and sex for at least one applicant and applicant multimedia data for at least one applicant.

14. The method of claim 11 further comprising marketing video recording services to at least one high school guidance counselor and providing video recording services to at least one high school guidance counselor.

15. The method of claim 11 further comprising offering access to certain portions of the website to admissions personnel at no cost.

16. The method of claim 11 further comprising offering access to a first portion of the website to potential applicant customers at no cost and offering access to a second portion of the website to potential applicant customers for a fee.

17. The method of claim 16 further comprising offering access to a third portion of the website to potential admissions customers at no cost and offering access to a fourth portion of the website to potential admissions customers for a fee.

18. The method of claim 11 further comprising permitting access to a portion of the website that permits a first searching function configured to search the website for applicants having attributes within a first set of attributes.

19. The method of claim 18 further comprising permitting access to a portion of the website that permits a second searching function that is configured to search the website for applicants having attributes within a second set of attributes, the second set of attributes having more searchable attribute categories than the first set of attributes.

20. The method of claim 19 further comprising charging a fee for use of the second searching function.

21. The method of claim 11 wherein the website is configured to permit at least one authorized person to copy the at least one video.

22. The method of claim 21 further comprising permitting users to provide the website with applicant data that is comprised of applicant information, the applicant information comprised of at least one of attributes, background information, academic performance, work experience, volunteer experience, ethnicity and sex for at least one applicant and applicant multimedia data for at least one applicant.

23. The method of claim 22 further comprising charging a fee to search or review the applicant data.
